(19) United States
(12) Patent Application Publication
(10) Pub. No.: US 2009/0056249 A1
(43) Pub. Date: Mar. 5, 2009

(54) Modular space dividing system

(76) Inventors: Ilan Premislav, Hadera (IL); Matan Shachar, Hod Hasharon (IL); Ariel Strykowsky, Jerusalem (IL)

Correspondence Address: THE NATH LAW GROUP, 112 South West Street, Alexandria, VA, 22314, US

(21) Appl. No.: 11/666,603

(22) PCT Filed: Oct. 20, 2005
(86) PCT No.: PCT/IL05/01103

§ 371 Date: Apr. 30, 2007

(30) Foreign Application Priority Data
Oct. 28, 2004 (IL) 164895

(51) Int. Cl. E04B 2/52; E04B 2/74; E04B 2/42

(52) U.S. Cl. 52/220.7; 52/745.13

(57) ABSTRACT

A modular space dividing system comprising at least one panel comprising two parallel surfaces and at least one cover-plate adapted to be connectable to the at least one panel. The at least one cover-plate is detachably mountable to the at least one panel and spaced apart therefrom by a distance defined by connecting members whereby an interstice is formed providing a raceway for conduits.

### FIELD OF THE INVENTION

The present invention is in the field of space dividing systems and more particularly it relates to modular wall panels and partition systems.

### BACKGROUND OF THE INVENTION

Effective planning and layout of space is an important aspect of a functional work or activities area. When the occupancy of a space changes, often the layout of the space needs to change to suit the needs of the new tenants, workgroup, or function.

Temporary partitions are commonly used to effect such changes, for example, to subdivide an open room into individual workspaces. These partitions are easier to install than gypsum walls. They also may be designed to coordinate with other furniture components to define an equipped workstation, and can be moved easily to new office locations. However, due to their temporary nature, they do not provide traditional closed offices; rather, they provide an open workspace without sound attenuation or separation of heating, ventilation, and air conditioning (HVAC), electrical, lighting and other physical support services between workstations.

Modular space dividing systems offer solutions for the above issues, generally providing prefabricated segments that may be assembled onsite to form walls, doors, windows, furniture systems, and the like. Additionally, these systems can typically be deconstructed in such a way that the segments are reusable for other construction. Modular space dividing systems typically provide raceways for placement of conduits, including piping, electric utilities, and other pathways for utility services. Hereinafter in the specification and claims, the general term “conduit” will be used to refer to any of the above mentioned pathways.

Examples of such systems are described in U.S. Pat. No. 3,927,498, U.S. Pat. No. 5,056,285, U.S. Pat. No. 5,809,708, and EP 1,245,750. U.S. Pat. No. 3,927,498 discloses a space partitioning system utilizing prefabricated elements constituting a framework and consisting essentially of tubular main posts and small posts, and trussed beams supported thereby. The floor and ceiling structures comprise trough-shaped elements and/or flanged tubs bolted to the posts. The walls are formed by composite hollow panel structures filled with insulating material. All the components, including door and window frames, have modular dimensions and are prefabricated and adapted to be assembled at the building site.

U.S. Pat. No. 5,056,285 discloses a partition wall comprising a frame having a number of vertical uprights and crosspieces, and covered on both faces by a number of panels, whereby the vertical uprights are formed from a bent sheet metal section with clinched lateral edges defining a hollow, substantially rectangular central portion and two opposed, substantially C-shaped lateral portions with turned-in ends.

U.S. Pat. No. 5,809,708 discloses integrated prefabricated structures for finishing or fitting-out open plan building spaces. The structure comprises three wall systems: a demountable architectural wall system which covers the fixed walls of the building room, a portable partition wall system defining the interior space into individual work settings, and a demountable movable wall system forming custom width partitions. The three wall systems are completely compatible and fully integrated in function and appearance, and provide utility raceways at common heights, as well as interchangeable cover panels. A modular column cover system selectively covers the support columns in the building room, and provides vertical utility routing and storage that integrates with the raceways in the wall systems. Pre-assembled facades, a freestanding storage case system, a space frame system, a prefabricated low raised floor construction, a modular overhead link head system, and accessories are disclosed and are designed to be used anywhere throughout the system, and to serve to personalize the various individual work settings to accommodate specific users and tasks.

EP 1,245,750 discloses a modular construction and enclosure system with reusable panels to form partitions. The basic panels have a perimeter grooving occupied by a C-section joint arranged with the opening outwards, and can be lined on one or two of their faces with a decorative panel which, in turn, can be veneered with ceramic pieces or other materials. The joint is secured with clamps and a front section set. The partitions are attached by disks comprising a central stub which is inserted into the section. If the partitions are to be constructed on a non-level floor slab, a skirting board with leveling feet may be used. Coplanar panels are joined by pincers, and corner panels are joined with clamps or universal joints. The edges of the partitions are lined with ornamental sections. The electrical installation elements are arranged on support boards with dorsal grooves.

### SUMMARY OF THE INVENTION

The present invention provides a space dividing system for the construction, covering, and decoration of partitions and a method for its construction. Hereinafter in the specification and claims, the general term “partition” will be used to refer to any partition, such as a wall, a ceiling, a floor, or the like.

The system according to the invention comprises a plurality of panels forming a wall or partition, each of the panels having two parallel planar faces and a connecting arrangement for securing thereto cover-plates leaving there between an interstice useful as a raceway for conduits and the like.

The cover-plates include an inner face attachable to the planar faces of the panels. Typically, the cover-plates are easily detachably connectable to the planar faces of the panels by way of engaging corresponding connecting members to each other, whereby the panel and cover-plate are spaced apart from one another to form the interstice.

To facilitate simple and fast adjacent/detachment of the cover-plates from the panels, there are provided connecting members, which may be of any type, such as male/female connectors, bolts, rivets, hooks, hook and pile fasteners (Velcro™), etc. or a combination of fasteners.

According to some embodiments, the connecting members serve as spacers for giving rise to the interstice between the panels and the cover-plates. Thus, the connecting members may assume different sizes to correspond with different interstice sizes, as may be required for different conduits.

The cover-plate has an outer face oriented away from the partition and which may be adapted for ornamentation. The ornamentation may be pre-formed, or may be applied at any time thereafter.

According to one particular aspect of the present invention, there is provided a wall covering system, for applying over existing walls, e.g. for obtaining an eye-pleasing effect. The system comprises cover-plates attachable at their inner face to the existing wall's faces. The cover-plates are detachably connectable to the walls by connecting members as discussed above, whereby the panel and cover-plate are spaced apart from one another to form the interstice.

The system may further include vertical support columns and horizontal beams for providing the structure rigidity. They are also useful for forming openings for doors, windows, and the like.

A further aspect of the invention, is a method for construction of partitions and planer structures, the method comprises attaching panels in an installed position to form a planar structure, and attaching cover-plates on surfaces of the planar structure, forming an interstice there between, providing a raceway for conduits.

The planar structures may be attached to each other to form various more complex structures.

The space dividing system of the present invention may be assembled substantially without the use of tools, causing only minimal damage to the existing walls, ceilings, and floors, and without leaving excess waste that needs to be discarded. It may be assembled on finished floors or carpeting, and disassembled and reassembled many times without substantial wear and tear thereto. The raceways are formed in such a way so that conduits may be placed in almost any location and position, and may be easily moved. The cover-panels are easily detachable for servicing the conduits and may be changed, making redecorating a room a simple task not requiring a professional.

The space dividing system may also be used as a veneer or cover for an existing wall, by constructing it adjacent thereto.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1A is a perspective view of a partially constructed space dividing system according to the present invention;

FIG. 1B is a section of the space dividing system of the present invention taken along line II-II in FIG. 1A;

FIG. 2 is a similar view as of FIG. 1, illustrating an alternative embodiment of the space dividing system of the present invention;

FIG. 3 is a front view of a wall constructed according to the embodiment shown in FIG. 2, without the cover-plates;

FIG. 4 is an exploded perspective view of a panel according to an embodiment of the present invention;

FIG. 5 is a rear perspective view of a cover-plate for use in conjunction with a panel as in FIG. 4;

FIG. 6 is a schematic sectioned view of a portion of a wall according to a modification of the invention;

FIG. 7 is a perspective view of the top of a panel of the space dividing system of FIG. 1A;

FIG. 8 is an enlargement of portion XIII in FIG. 1A, showing a fastening arrangement for assembling components of the space dividing system;

FIGS. 9A, 9B and 9C illustrate securing arrangements of the space dividing system, wherein:

FIG. 9A is a perspective view of a securing arrangement using clips; and

FIGS. 9B and 9C are side views of connecting arrangements incorporated into connecting members;

FIGS. 10A and 10B are plan sectioned views of arrangements for connecting paneled walls of the space division system to form a corner or intersection, respectively; and

FIG. 11 is a partial perspective view of the side of a wall according to the present invention.

### DETAILED DESCRIPTION OF THE INVENTION

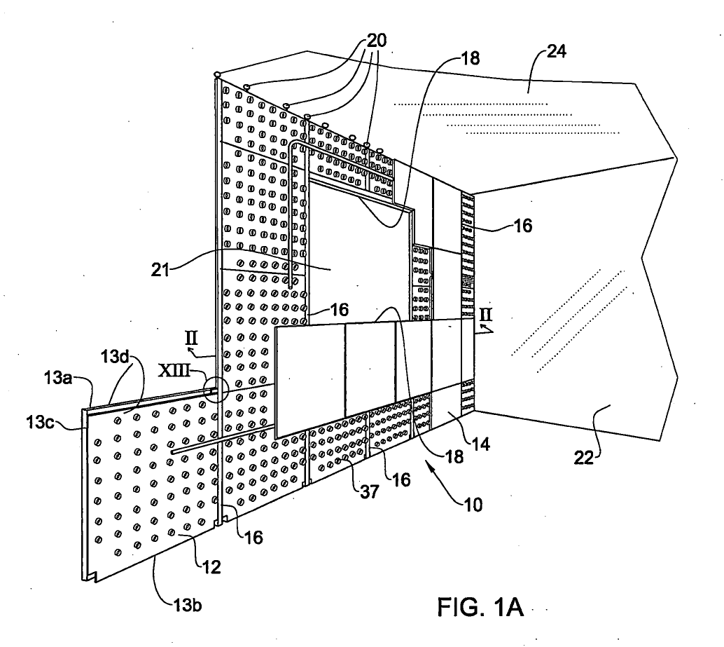

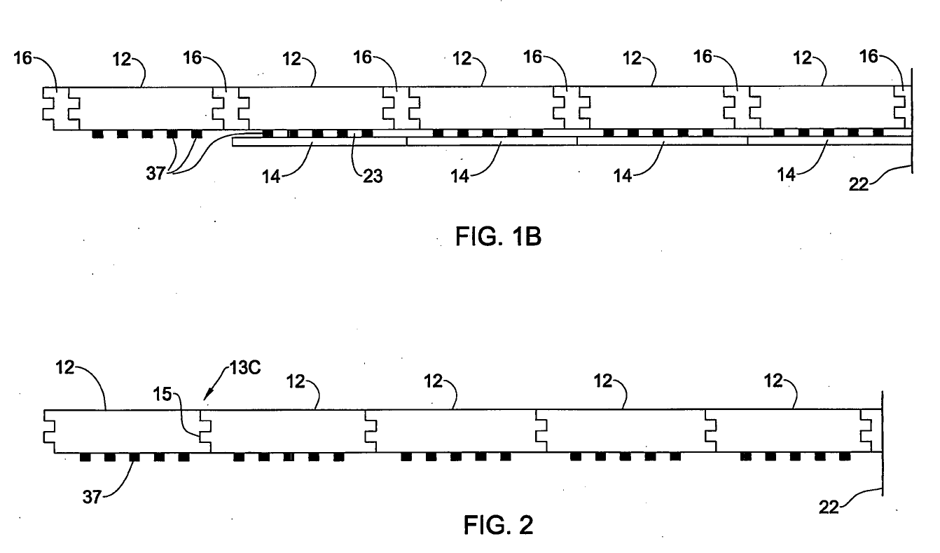

FIG. 1A illustrates a partially constructed modular space dividing wall system or wall, generally designated 10, according to an embodiment of the present invention. The wall 10 may be full-height or partial-height, and may be used to subdivide an existing space, cover an existing wall 22, or construct a new space. The space may be fully or partially enclosed, and it may be indoors or outdoors.

The wall 10 comprises panels 12, each having a top edge 13a, a bottom edge 13b, two side edges 13c, and two faces 13d. The panels 12 may be of any suitable material, but ideally are composed of a polymeric substance, such as high density polyethylene (plastic), reinforced plastic, polycarbonate, PVC, and the like. The panels 12 may optionally be composed of a flame-retardant or recyclable material.

The panels 12 are connected to form a vertical stack 19, which can be attached one to another to form the modular wall 10, and the modular wall 10 can be attached to the existing wall 22. The top edge 13a of each panel 12 is adapted to interlock (e.g., by a male/female arrangement) with the bottom edge 13b of the panel above it. Panels 12 are arranged thusly atop one another, forming the vertical stack 19. Additional vertical stacks 19 may be added to form the wall 10, until a desired wall length is achieved.

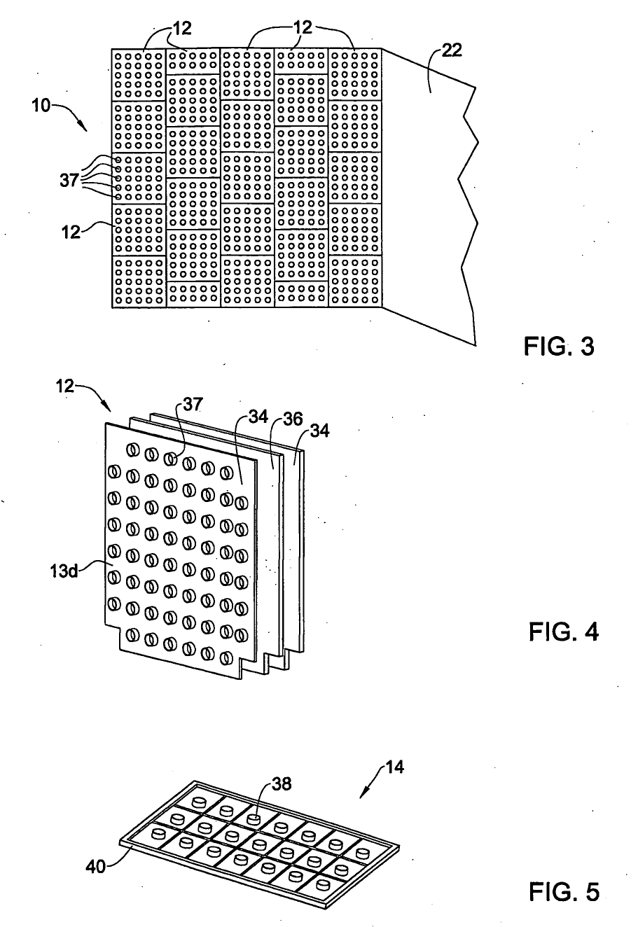

The vertical stack 19 may be attached to the vertical columns 16, which provide support for the wall 10. Alternatively, the stack 19 may be assembled in a staggered fashion as shown in FIG. 3. For this purpose, the side edges 13c of the panels 12 are adapted to interlock with edges of the columns 16.

The wall 10 further comprises cover-plates 14 attached to the panels 12, vertical columns 16, horizontal beams 18, and extension members 20 which are attached to the panels 12, vertical columns 16, and/or horizontal beams 18. The vertical columns 16 may be attached to the existing wall 22.

An important feature of the invention can be seen also in FIG. 1B, in which additional elements of the system are seen. Spacing or connecting members 37 form interstices 23 between the panels 12 and the cover-plates 14 giving rise to a raceway suitable for introducing various conduits e.g. electric and telecom wiring, sanitary piping, etc. The side edges 13c of the panels 12 have arrangements 15 whereby panels 12 may be interconnected with elements, such as other panels 12 or vertical columns 16.

According to one particular embodiment, the side edges 13c are adapted to interconnect with the columns 16, and the top edges 13a of the panels 12 are adapted to interconnect with the bottom edges 13b of other panels 12. Top edges 13a and bottom edges 13b are adapted to interconnect with horizontal beams 18. All of the aforementioned interconnections may be accomplished with the use of male/female connections, or the like.

FIG. 2 shows an additional embodiment of the wall 10 (not illustrating the cover-plates), wherein the panels 12 are interconnected directly to one another without the vertical columns 16 therebetween. A staggered arrangement of panels 12, as seen in FIG. 3, provides stability for the wall. This staggered arrangement can also used for the embodiment shown in FIGS. 1A and 1B.

The space dividing system may include openings 21, e.g., windows, doors, and the like. For this purpose, the openings 21 are typically, though not necessary, defined above and below by horizontal beams 18. In the case of an opening which abuts the floor or ceiling, the opening may be defined at the top or bottom, respectively, without a horizontal member 18.

The horizontal beams 18 are attachable (e.g., snappably, slideably, or by a coupling or connecting element) at their ends to a vertical column 16 and along their length to a panel 12, or vice versa.

FIG. 4 shows an exploded view of the panel 12, which comprises an outer frame 34, which may be constructed of more than one piece, and an inner core 36. The inner core 36 is typically made of a material which provides thermal insulation and acoustic attenuation, such as polyurethane. This may be in the form of boards of material, a sprayed layer, rigid foam, or an insulation blanket. Projecting from the faces 13d of the panel 12 are the connecting members 37, which also act as spacers. They may be integral to the panel 12 or detachably fastened thereto. The connecting members 37 may be sized to allow a standard electrical outlet, electrical switch, telephone jack, or the like, to be incorporated into the wall 10. The panel may be a priori compacted and sandwiched together or may be assembled onsite, with the inner core 36 selected and introduced according to particular requirements.

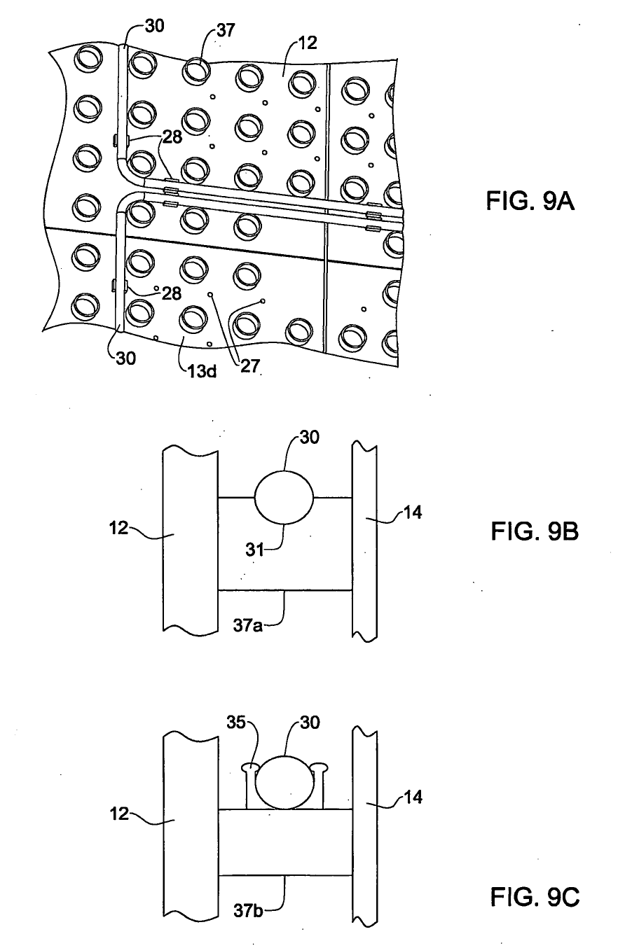

FIG. 5 shows further details of a cover-plates 14 of the present invention, wherein it comprise receiving members 38, adapted to mate with the connecting members 37 of the panel 12. The connecting members 37 keep the cover-plates 14 at a distance so that an interstice 23 is formed, providing raceways for running conduits 30 (FIG. 9A). These conduits 30 may include electrical, telephone, or communications wiring, piping, heating, ventilation, and air conditioning services, and other utilities. Providing raceways in such a manner allows conduits 30 to be placed at any height along the wall, and to follow virtually any desired path therein.

An outer surface 40 of the cover-plate 14 may comprise a decorative face, and may, for example, be preformed with an aesthetic pattern or texture, or may be adapted to receive a wall covering, such as a decal, an ornament, or a liquid pigment coating such as paint.

It is appreciated that the size of the cover-plates typically corresponds with that of the panels, though they may both be made of material easily re-sized onsite, e.g. by using a jigsaw or other suitable tool. To facilitate this, the panel 12 is formed with pairs of projecting parallel strips 42, each pair forming between them a groove 44 (FIG. 11). The pairs of strips 42 extend along the faces 13d of the panel, typically in a grid formation, forming thereby scoring mark useful as a guide for cutting. It should be noted that the panel 12 is adapted to be cut anywhere; the strips 42 only act as guides in places where a panel 12 is likely to be cut.

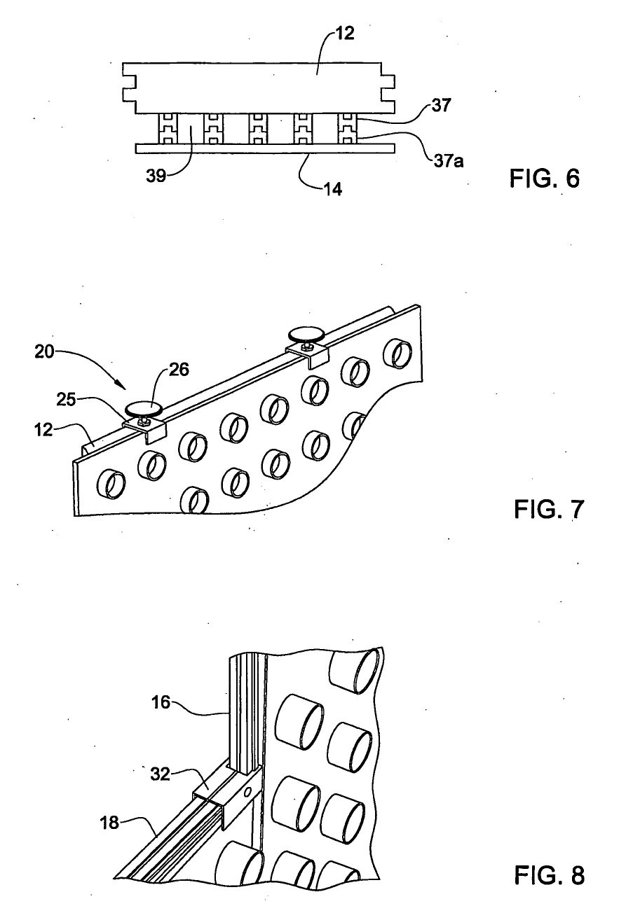

FIG. 6 shows an option whereby a larger raceway can be formed, wherein an expansion connecting member 37a is added intermediate to the panels 12 and the cover-plates 14 forming a larger interstice 39, thereby providing a larger raceway. The connecting members 37 or the receiving members 38, or both, may be integral to the panel 12 or the cover-plate 14 or may be removable (e.g., replaceable by connecting members 37 of a different size or shape, allowing for a space for larger or several conduits, and/or electrical outlets, etc.).

With further reference to FIG. 7, the wall 10 may comprise extension members 20 at the top edges 13a of the topmost panels 12 of the wall 10, for allowing the wall 10 to interface with an existing ceiling 24. These extension members 20 are attachable to the top of a panel 12, vertical column 16, or horizontal beam 18, and typically have a flat surface 26 for bearing against a ceiling (or floor) surface. They may be secured (e.g., by a screwing mechanism, pin and hole arrangement, etc.) directly to the panel 12, the vertical column 16, or the horizontal beam 18, or to a mounting bracket 25 attached to any of these.

During construction, the wall 10 is assembled until the top edges 13a of the topmost panels 12 are relatively close to the ceiling 24. The extension members 20 are then adjusted (e.g., by unscrewing, being outwardly snapped, etc.), extending them until the flat surface 26 snuggly engages the ceiling 24, rigidly fixing the wall 10 or vertical column 16 between the floor and the ceiling 24. Alternatively, the extension members 20 may be located at the bottom of the wall adjacent the floor or at the side of the wall 10 adjacent the existing wall 22 or another wall 10 (not shown).

FIG. 8 illustrates how a vertical column 16 and a horizontal beam 18 may be attached to each other by a fastening member 32. A window or door assembly (not shown), or other appropriate fixture, may be fitted within the opening 21 thus formed.

FIG. 9A shows how the conduits 30 may be placed and secured to the panels 12 of the wall 10. According to one embodiment of the present invention, at least one face 13d of at least one of the panels 12 comprises apertures 27, adapted to receive a fastening element, such as a snap-type clip 28. Such clips 28 are adapted to receive conduits 30 and maintain their position in the interstices 23 between the panel 12 and the cover plate 14, and they may be added as needed and may be relocated if conduits 30 are to be moved. The clips may also be integrated with the panels and according to another embodiment may be formed on an inner face of the cover-plate.

The connecting members 37 may additionally be adapted to support the conduits 30. FIG. 9B shows another example of a connecting member 37a, having an indentation 31 formed therein, providing a seat for the conduit 30. FIG. 9C shows yet another example of a connecting member 37b, comprising a clasp 35 adapted for holding the conduit 30. The clasp 35 may be integrally formed with the connecting member 37b, or may be adapted to be attached thereto.

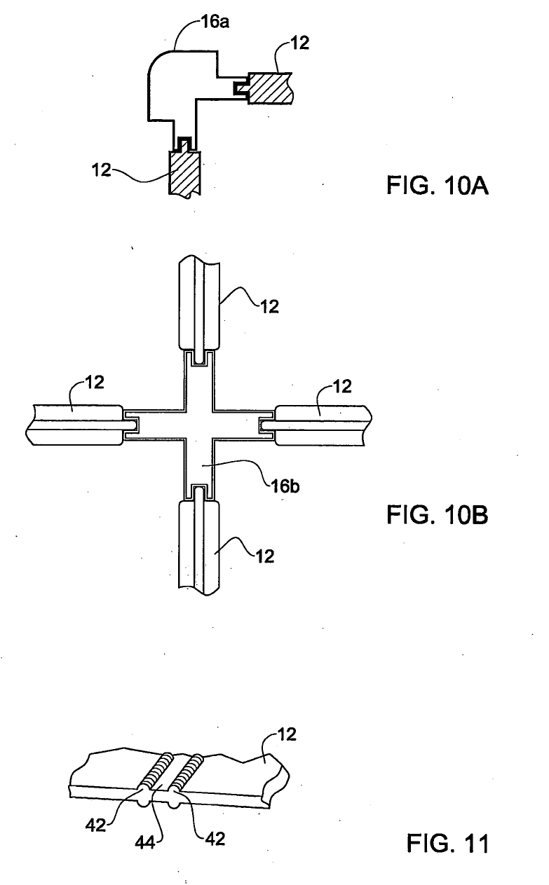

FIGS. 10A and 10B show exemplary connections between walls 10 to form corners, intersections, wall joints, and the like. FIG. 10A shows a vertical column 16a adapted to hold two vertical panels 12 together, for example at a right angle, as seen in the figure. However, it should be understood that columns 16a could be adapted for holding walls 10 together at various angles. This is useful, for example, in outdoor applications where there is no existing wall, and an outer boundary of an enclosed space needs to be defined by a self-supporting wall 10.

FIG. 10B shows a variation of the arrangement in FIG. 10A, wherein there is a vertical column 16b adapted to hold more than two walls 10 together, shown here in a cross pattern. While the figure illustrates four walls, it should be understood that the column 16b could be adapted to hold any number of walls 10 at various angles, and that one or more of the walls may be omitted.

Those skilled in the art to which this invention pertains will readily appreciate that numerous changes, variations and modifications can be made. For example, the space dividing system of the present invention can be used to form a ceiling, closets or other storage spaces, shelves, bars, etc., without departing from the scope of the invention mutatis mutandis.

1. A modular space dividing system comprising at least one panel comprising two parallel surfaces and at least one cover-plate adapted to be connectable to said at least one panel, wherein said at least one cover-plate is detachably mountable to said at least one panel and spaced apart therefrom by a distance defined by connecting members whereby an interstice is formed, said interstice providing a raceway for conduits.

2. A system according to claim 1, wherein at least one of an inner face of the cover-plate and an outside face of the panel are fitted with a connecting member for detachable connection there between.

3. A system according to claim 1, wherein a first connecting member extends from an outside face of the panel and a second connecting member extends from in inside face of the cover-plate, wherein said first and second connecting member are detachably attachable to one another.

4. A system according to claim 3, further comprising one or more expansion connecting members, intermediate the first connecting member and the second connecting member.

5. A system according to claim 1, further comprising at least one fastening element adapted for receiving and holding the conduits.

6. A system according to claim 5, wherein the fastening elements are integral with or attachable to one of the panel and the cover-plate.

7. A system according to claim 5, wherein at least some of the connecting members are adapted to support the conduits.

8. A system according to claim 1, wherein a plurality of panels are attachable to one another to form a partition.

9. A system according to claim 8, wherein the panels are snappingly attachable to one another.

10. A system according to claim 1, wherein the panels comprise a core layer intermediate to the two parallel surfaces, said core layer being made of a thermally insulating and/or acoustically attenuating material.

11. A system according to claim 1, comprising an arrangement for fixedly extending the system between an existing floor and ceiling, or existing walls.

12. A system according to claim 1, further comprising vertical columns extending at least the height of two panels in an assembled position, said vertical columns being attachable to the panels.

13. A system according to claim 12, wherein the vertical columns are attachable to panels from two or more sides.

14. A system according to claim 12, wherein the vertical columns are attachable to at least one panel at a first side, and attachable to an existing wall at a second side.

15. A system according to claim 1, further comprising at least one horizontal member, attachable at both ends to at least one component of the system, said horizontal members being further attachable along its length to the at least one component of the system, wherein the component is one of a panel or a column.

16. A panel for construction of modular space dividing system, said panel comprising two parallel surfaces and a core layer intermediate to the two parallel surfaces, with connecting members for detachably attaching thereto cover-plates.

17. A panel according to claim 16, further comprising at least one fastening element adapted for receiving and holding conduits.

18. A panel according to claim 16, wherein the panels are snappingly attachable to one another.

19. A panel according to claim 16, wherein one or more side edges of panel are fitted with attachments for interconnecting to neighboring panels.

20. A panel according to claim 16, wherein one or more side edges of panel are fitted with attachments for interlocking with support columns and beams.

21. A cover-plate in combination one or more panels and being attachable thereto, the cover-plate having an outer face adaptable for ornamentation.

22. A cover-plate according to claim 21, wherein the outer face is adapted to receive a wall covering.

23. A cover-plate according to claim 22, wherein the covering is one of a decal, an ornament, and a liquid pigment coating.

24. A cover-plate according to claim 22, comprising connecting members for detachably attaching to panels of a partition.

25. A method for constructing a modular space dividing system comprising:
(a) providing panels adapted to be attached one to another at their edges, flush with one another;
(b) attaching the edges of said panels one to another to form a planar structure;
(c) providing cover-plates adapted to be attached to the planar structure; and
(d) attaching cover-plates to the planar structure via connecting members;
said connecting members providing a distance between the panels and the cover-plates thereby forming an interstice between the planar structure and the cover-plates, providing a raceway for conduits.

26. A method according to claim 25, further comprising:
(a) providing vertical support members adjacent at least some of the panels;
(b) attaching said vertical support members to the panels; and
(c) rigidly fixing the vertical support members between a floor and a ceiling.

27. A method for covering a partition, the method comprising:
(a) providing a cover-plate, at least one surface of which is adapted for ornamentation; and
(b) attaching the cover-plate to the partition, with said surface disposed away from the partition.

28-34. (canceled)
